(19) United States
(12) Patent Application Publication
(10) Pub. No.: US 2019/0344503 A1
(43) Pub. Date: Nov. 14, 2019

(54) CARTRIDGE AND PRINTING SYSTEM FOR PRINTING THREE-DIMENSIONAL PARTS

(71) Applicant: VIACCESS, Courbevoie (FR)

(72) Inventor: Emmanuel PIRA, MELESSE (FR)

(21) Appl. No.: 16/474,855

(22) PCT Filed: Dec. 27, 2017
(86) PCT No.: PCT/EP2017/084639

§ 371 Date: Jun. 28, 2019

(30) Foreign Application Priority Data
Dec. 30, 2016 (FR) 16 63561

(51) Int. Cl. B29C 64/259; B33Y 30/00; B33Y 50/02; B29C 64/393

(52) U.S. Cl. CPC B29C 64/259; B29C 64/393; B33Y 50/02; B33Y 30/00

(57) ABSTRACT

The invention relates to a printing cartridge (46) for a system (30) for printing three-dimensional parts, containing at least one store (48) for printing material. Said cartridge includes a module (50) for accessing code instructions (52) that can be executed by the printing system in order to print at least one three-dimensional part in a predetermined form using the printing material(s) contained in the cartridge. The invention also relates to an associated system for printing three-dimensional parts.

The present invention relates to a printing cartridge for a system for printing three-dimensional parts, and an associated system for printing three mentioned parts.

The invention falls within the field of 3D printing using dedicated printing systems, more commonly called 3D printers.

In recent years, the 3D printing market has been in full expansion, both for professional use and for individual use.

There are many reasonably priced models of 3D printers, sold for individual use, for example for printing recreational or artistic objects.

Another use of 3D printers is printing various spare parts for various devices, in particular in the household appliance field.

Such parts have precise specifications regarding the materials to be used, and the three-dimensional shape of the part.

The known 3D printing systems have a printing head and a printing surface, which are movable relative to one another in translation along three axes, making it possible to print a three-dimensional part with a predetermined shape by successive layers, the printing head being supplied with printing material(s). For example, the printing material is a fusible filament, and the printing head is supplied therewith using a spool around which it has previously been wound.

To produce one or several parts with a predetermined three-dimensional shape, the known 3D printers use executable printing code instructions in an appropriate command language, executable by a microcontroller that controls the relative movements in space, along all 3 movement axes, of the head and the printing surface, as well as the quantities of printing materials to be used.

The printing instructions are for example sent to the printing system via a USB (Universal Serial Bus) port from another device, or via a memory card, for example an SD (Secure Digital) card, inserted into a dedicated reader of the printing system.

In the systems in which the printing material is a fusible filament, the user can be called upon to intervene manually to change the spool of filament to be used, for example to vary the color or any other property of the printing material, for example its hardness, its elasticity or its density. There is then a risk of printing, deliberately or not, parts that do not comply with their legitimate design.

Thus, it would be useful to develop a 3D printing system that is simpler to use, makes it possible to reduce the above risk, and makes it possible to limit the possible use of executable code instructions, and in particular the number of printing operations that can be done. To that end, the invention seeks to provide, integrally, the executable printing code instructions for a predetermined part, as well as the material necessary for that printing.

To that end, the invention proposes a printing cartridge for a system for printing three-dimensional parts, containing at least one store of at least one printing material. This cartridge includes a module for accessing code instructions executable by the printing system for printing at least one three-dimensional part with a predetermined shape by using the printing material(s) contained in the cartridge.

The printing cartridge for a system for printing three-dimensional parts according to the invention may have one or more of the features below, considered independently or in all technically acceptable combinations.

The store(s) of printing material(s) contained in the cartridge comprise the printing material(s) in predetermined quantity or quantities, necessary and sufficient to perform the printing of a predetermined number of said three-dimensional parts.

The access module is an electronic storage unit able to store data, and the cartridge further includes at least one connection unit suitable for connecting to a corresponding receiving unit belonging to a printing cartridge holder of said printing system, said connection unit being suitable for sending said stored data to a computing and command unit of the printing system via said receiving unit.

The access module stores the code instructions in a suitable machine command language.

The access module stores an access identifier including an address for accessing, in a telecommunication network, said code instructions on a remote server.

The module for accessing code instructions is an identifier arranged or etched on an outer face of the printing cartridge, said identifier encoding an address for accessing, in a telecommunication network, said code instructions on a remote server.

The printing material comprises at least one fusible filament, or a printing liquid or a printing powder.

The store of printing material includes a spool to be unwound from at least one type of fusible filament.

The cartridge includes a heating nozzle suitable for transforming said fusible filament into liquid material suitable for printing a three-dimensional part by layers.

The cartridge includes at least one sensor from among a temperature sensor and a filament type change sensor.

According to another aspect, the invention relates to a system for printing three-dimensional parts that includes a cartridge holder suitable for receiving a printer cartridge as briefly described above.

According to one feature, the cartridge holder includes a connection interface suitable for recovering an identifier for accessing code instructions for printing a three-dimensional part or code instructions for printing at least one three-dimensional part by using the printing material(s) contained in said cartridge.

Other features and advantages of the invention will emerge from the description thereof provided below, for information and non-limitingly, in reference to the appended figures, in which:

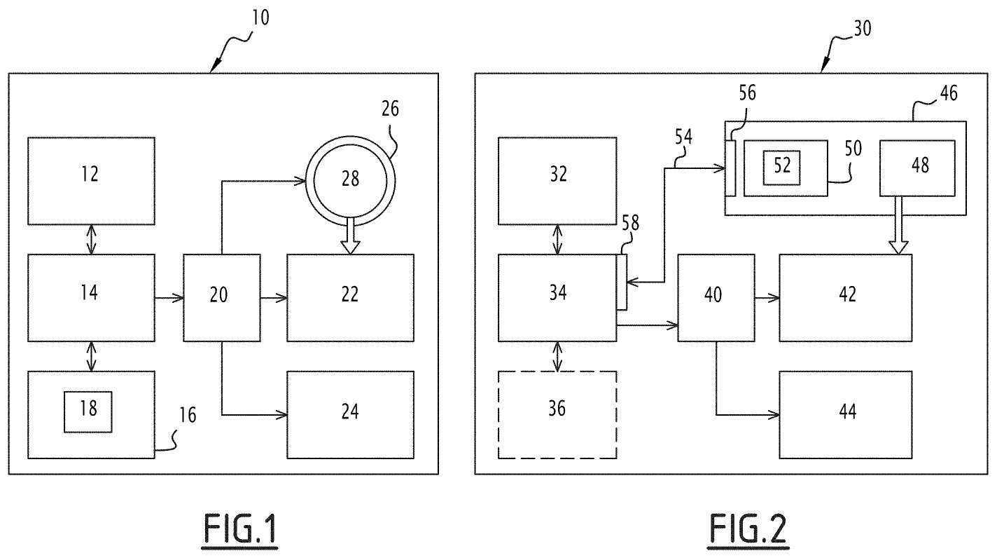

FIG. 1 schematically illustrates the functional blocks of a 3D printing system according to the state of the art;

FIG. 2 schematically illustrates the functional blocks of a 3D printing system according to a first embodiment of the invention;

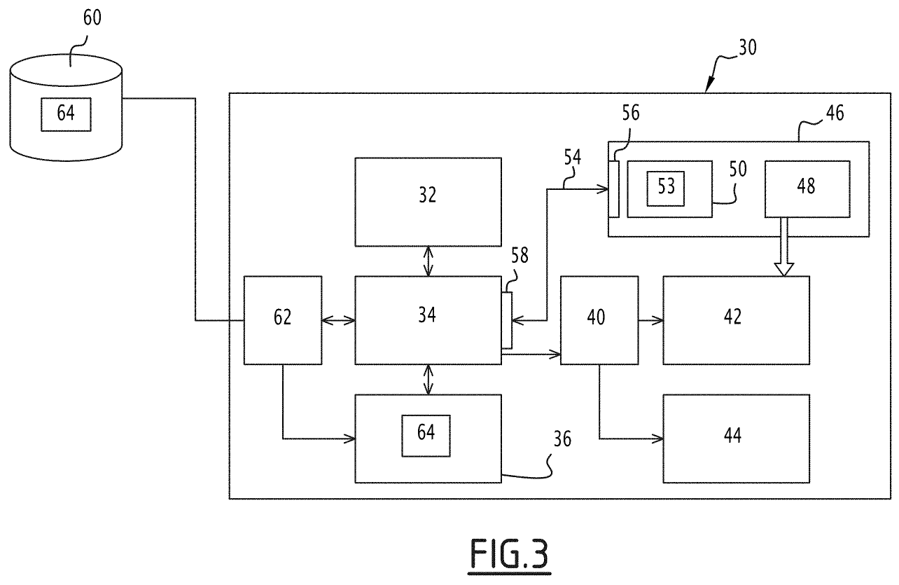

FIG. 3 schematically illustrates the functional blocks of a 3D printing system according to a second embodiment of the invention;

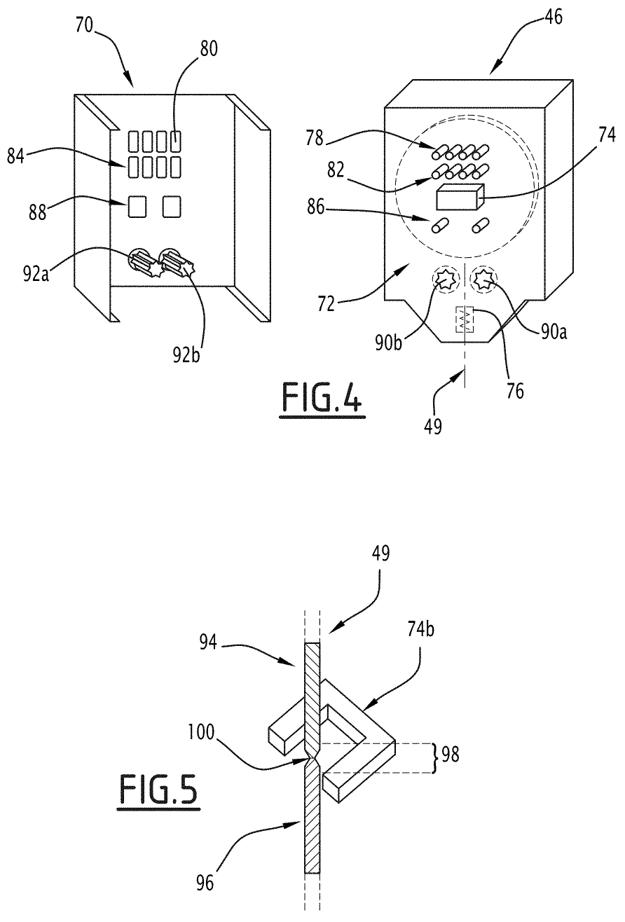

FIG. 4 schematically illustrates a printing cartridge part and a corresponding cartridge holder according to one embodiment of the invention;

FIG. 5 schematically illustrates another printing cartridge part according to one embodiment of the invention.

FIG. 1 schematically shows the functional blocks of a conventional 3D printing system according to the state of the art.

The printing system 10 comprises a user interface 12, having various interaction elements (buttons, touchscreen) allowing a user to control the printing system 10.

The printing system 10 also comprises a computing and command unit 14, having one or several processors, suitable for executing computer program instructions and commanding the operation of the elements of the printing system 10 when it is powered on.

In a variant, the computing and command unit 14 is a programmable logic circuit of the FPGA or ASIC type.

The system 10 also includes a memory unit for storing electronic information 16, able to store executable code instructions, in particular code instructions 18 describing the movements to be performed by the printing head and the printing surface to reproduce the three-dimensional shape of a part to be printed and making it possible to command the printing of such a part.

For example, the executable code instructions 18 are in G-code format, or any other digital machine command language.

The information storage unit 16 is any removable medium, for example an SD card, which the user inserts into a dedicated reader of the system 10.

In a variant, the information storage unit 16 is integrated into the system 10.

In a variant, the executable code instructions 18 are received by the storage unit 16 via a network communication unit, not shown, on command by the user.

The functional blocks 12, 14, 16 are connected via a communication bus.

The computing and command unit 14 is suitable for commanding a movement command unit 20, suitable for commanding the movement along the movement axes provided with a printing head 22 and a printing surface 24 on which the successive layers of material are deposited to form one or several three-dimensional parts.

The printing head 22 is movable along at least one spatial direction, and receives a printing material to produce a 3D part from the unit 26 for supplying printing material.

For example, the unit 26 for supplying printing material is formed by a spool 28 of fusible filament, for example plastic material, the filament being unwound over the course of the printing, and the printing head 22 comprises a heating nozzle (not shown), which melts the filament in order to deposit it in liquid form layer by layer to form the 3D part.

The unwinding of the spool 28 of fusible filament is for example also controlled by the movement command unit 20.

FIG. 2 schematically illustrates the main functional blocks of a 3D printing system 30 according to a first embodiment of the invention.

The 3D printing system 30 includes a user interface 32 and a computing and command unit 34, which are respectively similar to the units 12 and 14 described above.

It also includes an information storage unit 36, a movement command unit 40, a printing head 42 and a printing surface 44.

According to one variant, the units 34 and 36 are integrated into a microcontroller.

However, unlike the printing system 10, the printing system 30 includes a removable cartridge 46 containing both at least one store 48 of a material for printing 3D parts and a module 50 for accessing code instructions to command the printing system to print predetermined three-dimensional parts. The module 50 allows access to executable code instructions, for example in G-code command language, to command the printing of three-dimensional parts with a predetermined shape using the material(s) contained in the removable cartridge 46. The cartridge contains materials for printing a predetermined number N of these parts.

In the embodiment of FIG. 2, the module 50 for accessing code instructions is an electronic information storage unit, for example a memory card, storing executable code instructions 52.

Preferably, the store 48 includes the necessary and sufficient quantity of printing materials to allow the printing of a predetermined number of three-dimensional part(s) of predetermined shape(s).

Advantageously, providing the appropriate quantity of printing materials limits the use of the executable code instructions 52, and therefore limits the number of printable copies of the predetermined three-dimensional part(s), and further prevents any waste.

The executable code instructions 52 are sent to the control and command unit 34 via a data communication link 54 when the removable cartridge 46 is fastened according to a fastening mode provided in the printing system 30.

For example, in one embodiment, the removable cartridge 46 includes a connection unit 56, suitable for connecting to a receiving unit 58 of the 3D printing system, thus making it possible to produce a data transmission link 54.

For example, the connection unit 56 is a connector of the USB type, and the receiving unit 58 is a USB port suitable for receiving the USB connector when the cartridge 46 is inserted into the slot provided to that end in the printing system 30.

According to a second embodiment of a printing system, illustrated in FIG. 3, the information storage unit 50 belonging to the removable cartridge 46 stores an access identifier 53, for example an identifier including an address for accessing, in a telecommunication network, for example in the form of a URL (Uniform Resource Locator), a remote server 60 where a set of executable code instructions is stored making it possible to produce the predetermined three-dimensional part(s).

In this embodiment, the 3D printing system 30 further comprises a communication module 62 allowing a connection to a telecommunication network and the downloading of executable code instructions 64 at the URL address extracted from the access identifier 53. The code instructions 64 are for example stored by the information storage unit 36 after downloading.

According to one variant, the code instructions are stored in encrypted form, and the information storage unit 50 also stores a cryptographic decryption key making it possible to decrypt the code instructions. The cryptographic key is sent to the computing and command unit 34 via the link 54.

According to another variant, the code instructions 64 are sent on the fly, i.e., as they are downloaded by the communication module 62, to the control and command module 34, and executed by the latter in real-time, without being stored in the information storage medium 36 for longer than necessary for this execution.

According to another variant of this second embodiment, the module 50 for accessing code instructions to command the printing system to print three-dimensional parts is made by an identifier arranged or etched on an outer face of the removable cartridge, in a predetermined location, for example an identifier of the QR code or barcode type, which includes an address for accessing, in a telecommunication network, for example in the form of a URL, the remote server 60 where a set of executable code instructions 64 is stored making it possible to produce the predetermined three-dimensional part(s).

In this variant, the cartridge holder suitable for receiving the removable cartridge is equipped with a suitable reader, for example a laser diode reader, positioned so as to read the corresponding QR code- or barcode-type identifier.

FIG. 4 schematically shows a semi-perspective view of a face 72 of a removable cartridge 46 according to a first embodiment, and a corresponding view of a cartridge holder 70 belonging to a 3D printing system according to the invention.

The elements shown in FIG. 4 produce an electromechanical interfacing system between the removable cartridge and the cartridge holder of the printing system, allowing operation when the removable cartridge is inserted into this holder.

As illustrated schematically, the cartridge holder 70 has a shape suitable for receiving the removable cartridge 46 so as to produce mechanical coupling and a plurality of electrical connections.

In this embodiment, aside from the store of material(s) 48 for printing 3D parts and the module 50 for accessing code instructions to command the printing system, the cartridge 46 comprises at least one sensor 74, which is a temperature sensor, to obtain temperature information at given regular time intervals.

In a variant, several other sensors suitable for providing information are present, for example including a filament type change sensor as described hereinafter.

In the illustrated embodiment, the printing material is a fusible filament 49, and the cartridge also comprises a heating nozzle 76, in which the fusible filament is inserted over the course of the printing.

Furthermore, the face 72 of the cartridge 46 is provided with a set of protruding connection elements 78, suitable for being inserted into receiving slots 80 of the cartridge holder 70, to form a connection, allowing the transmission of data from the access module 50 (not shown in FIG. 4). The connection elements 78 are connected to the access module 50.

The connection elements 78 and the receiving slots 80 respectively correspond to embodiments of a connection unit 56 and a receiving unit 58, as described above in reference to FIGS. 2 and 3.

For example, the elements 78 and 80 produce a serial connection of the USB type or a parallel connection like for an SD card.

It should be noted that in the embodiment in which the module 50 for accessing code instructions to command the printing system is made by an identifier arranged or etched on an outer face of the removable cartridge, the contact elements 78 and 80 are not present. The cartridge holder 70 comprises a reader suitable for reading said identifier.

The face 72 of the cartridge 46 is provided with a set of protruding connection elements 82, inserted into receiving slots 84 of the cartridge holder 70, allowing the transmission of information obtained by the sensors 74. The connection elements 82 are connected to the sensors 74.

Lastly, the face 72 of the cartridge 46 comprises protruding contact elements 86, suitable for being inserted into receiving slots 88 of the cartridge holder 70, making it possible to produce an electrical contact to supply electricity to the elements of the removable cartridge, for example to supply electricity to the nozzle 76.

The face 72 of the cartridge 46 further comprises sleeves 90a, 90b, suitable each for receiving a shaft 92a, 92b, protruding on the cartridge holder 70, making it possible to produce a mechanical coupling. In the illustrated embodiment, two sleeves 90a and 90b are positioned so as to drive the filament 49 when the corresponding shafts 92a, 92b are in motion, which makes it possible to control the unwinding of the filament for the printing of a 3D part by rotating the shafts 92a, 92b via the movement command unit 40 of the 3D printing system.

The elements 80, 84, 88, 92a, 92b form a mechanical and electrical connection interface for the cartridge holder 70 with the removable cartridge 46, making it possible to recover both the printing code instructions and the information obtained by the sensors 74, and to command the use of the printing materials during the actual printing.

Advantageously, the cartridge 46 comprises the store 48 of a printing material suitable, in quality and quantity, to produce only the predetermined 3D parts, defined by the code instructions accessible via the access module 50.

It is then possible to choose, for example, a spool of filament containing several materials, with varied properties (hardness, elasticity, density or color, for example), matching the code instructions to be executed, to produce parts with a predetermined format.

Indeed, the part(s) to be printed are printed by layers of material successively stacked; it is therefore possible to compute the quantity of filament of a given type and/or color as a function of the volume of the corresponding layer(s) of material.

Preferably, the entire spool of filament is made up of a plurality of filaments, varying by type of material (e.g., plastic or rubber, conditioning their hardness, elasticity or density) and/or the color, which follow one another.

In order to produce the predetermined parts precisely, preferably, the spool of filament is made up of a plurality of filaments, and two successive filaments are connected to one another by a transitional segment having a mark capable of being detected by an appropriate filament change sensor, as illustrative schematically in FIG. 5 for one embodiment.

In the embodiment of FIG. 5, the spool 48 comprises a first filament 94, a second filament 96, connected by a transitional segment 98 having a mark 100.

The first type of filament 94 is made from a first material, for example plastic having a first hardness value, and having a first color. The first type of filament is cylindrical with a first diameter.

The second type of filament 96 is made from a second material, for example plastic having a second hardness value, and having a second color. The second type of filament is cylindrical with a second diameter, which can be equal to the first diameter.

In the illustrated embodiment, the mark 100 to be detected is a thinning of the first diameter of the first filament, this thinning being detected by a sensor 74b, which in this embodiment is an optical fork.

When the mark 98 passes in front of the sensor 74b, light variation information is detected. This information is transmitted, via the elements 82 and the connection with the elements 84, to the computing and command unit 34, which executes the code instructions for printing the 3D part.

The light variation information is for example used to command a purge of any surplus of the first material in a dedicated zone of the printer.

In a variant, the mark to be detected is a filament color change, and the sensor 74b is replaced by a colorimetric sensor.

In another variant, the printing cartridge includes several spools of filaments, and the selection of the filament of a given color or material is done electromechanically upstream from a heating nozzle able to receive, as input, several filaments or several heating nozzles respectively adapted to each of the filaments.

According to a second embodiment of the removable cartridge according to the invention, the cartridge does not comprise a heating nozzle, or sleeves suitable for receiving driveshafts of the filament, these elements being integrated into the holder suitable for receiving the removable cartridge, or in other parts of the 3D printing system.

In this case, the printing cartridge has a lower manufacturing cost.

According to one variant, the cartridge does not comprise a heating nozzle, but comprises sleeves as described above suitable for receiving driveshafts of the filament.

In the embodiments described above, the 3D printing is done by using the fusible filament.

In a variant, a removable cartridge according to the invention includes, as store(s) of printing material(s), one or several reservoirs of powder- or liquid-based material(s), and an electromechanical interfacing system adapted accordingly to command the supply of printing material(s) over the course of the execution of the code instructions by the computing and command unit of the printing system.

In general, various embodiment variants of a 3D printing system, in terms of materials used and arrangement, are compatible with the invention.

Advantageously, the supply of a printing cartridge including both at least one printing material and a module for accessing code instructions allowing the printing system to print at least one three-dimensional part with a predetermined shape by using the printing material(s) contained in the cartridge makes it possible to constrain both the use of the material solely to print the predetermined three-dimensional part(s), and the printing of the predetermined three-dimensional part(s) (i.e., the use of the corresponding executable code instructions) to be done only with the material integrally supplied, and therefore to decrease the risk of printing not compliant with its legitimate design of a predetermined part, and to limit the number of printable copies of the predetermined three-dimensional part(s).

Furthermore, this makes it possible, if applicable, to protect the printing code instructions, for example by using encryption, while controlling the number of parts manufactured.

1. A printing cartridge for a system for printing three-dimensional parts, containing at least one store of a printing material, comprising a module for accessing code instructions executable by the printing system for printing at least one three-dimensional part with a predetermined shape by using the printing material(s) contained in the cartridge.

2. The printing cartridge according to claim 1, wherein the store(s) of printing material(s) contained in the cartridge comprise the printing material(s) in predetermined quantity or quantities, necessary and sufficient to perform the printing of a predetermined number of said three-dimensional parts.

3. The printing cartridge according to claim 1, wherein said access module is an electronic storage unit able to store data, and the cartridge further includes at least one connection unit suitable for connecting to a corresponding receiving unit belonging to a printing cartridge holder of said printing system, said connection unit being suitable for sending said stored data to a computing and command unit of the printing system via said receiving unit.

4. The printing cartridge according to claim 3, wherein the access module stores the code instructions in a suitable machine command language.

5. The printing cartridge according to claim 3, wherein the access module stores an access identifier including an address for accessing, in a telecommunication network, said code instructions on a remote server.

6. The printing cartridge according to claim 1, wherein the access module for accessing code instructions is an identifier arranged or etched on an outer face of the printing cartridge, said identifier encoding an address for accessing, in a telecommunication network, said code instructions on a remote server.

7. The printing cartridge according to claim 1, wherein said printing material comprises at least one fusible filament, or a printing liquid or a printing powder.

8. The printing cartridge according to claim 1, wherein said at least one store of printing material includes a spool to be unwound from at least one type of fusible filament.

9. The printing cartridge according to claim 8, comprising a heating nozzle suitable for transforming said fusible filament into liquid material suitable for printing a three-dimensional part by layers.

10. The printing cartridge according to claim 8, comprising at least one sensor from among a temperature sensor and a filament type change sensor.

11. A system for printing three-dimensional parts comprising a cartridge holder suitable for receiving a printer cartridge according to claim 1.

12. The printing system according to claim 11, wherein said cartridge holder includes a connection interface suitable for recovering an identifier for accessing code instructions for printing a three-dimensional part or code instructions for printing at least one three-dimensional part by using the printing material(s) contained in said cartridge.
